(19) United States
(12) Patent Application Publication
(10) Pub. No.: US 2003/0046400 A1
(43) Pub. Date: Mar. 6, 2003

(54) Contacting a destination terminal from an originating terminal via a packet-based communications network

(76) Inventors: Owen Friel, Nuna Island (IE); Peter G. Tarle, Belleville (CA); Douglas R. Zork, Dallas, TX (US); Francois Audet, Campbell, CA (US)

Correspondence Address: Lee, Mann, Smith, McWilliams, Sweeney & Ohlson, P.O. Box 2786, Chicago, IL, 60690-2786, US

(21) Appl. No.: 09/935,253

(22) Filed: Aug. 22, 2001

(51) Int. Cl. G06F 15/16

(52) U.S. Cl. 709/228; 709/249

(57) ABSTRACT

The present invention concerns packet-based communications networks in which gateways are used to direct communications between terminals. For example, H.323 based communications networks are one example of this type of communications network. One problem relates to how such gateways can be enabled to direct communications between terminals in such a way that takes into account cost information and/or the fact that telephone numbers (or other identifiers) are repeated in different parts of the communications network. This is addressed by providing a gatekeeper with cost information associated with each gateway. An originating gateway sends a request to the gatekeeper comprising a unique identifier of that originating gateway and an identifier for a destination terminal. The gatekeeper uses this information to provide a reply comprising a list of all possible gateways that can be used to contact the destination terminal or a single preferred gateway. The list is preferably ordered on the basis of cost information and/or depending on which region in the network that the originating gateway is located.

### FIELD OF THE INVENTION

The present invention relates to a method and apparatus for contacting a destination terminal from an originating terminal via a packet-based communications network. The invention also relates to a gateway and a gatekeeper for use in such a communications network. The invention is particularly related to but in no way limited to large H.323 voice over internet protocol communications networks used by enterprises.

### BACKGROUND TO THE INVENTION

The present invention concerns packet-based communications networks in which gateways are used to direct communications between terminals. For example, H.323 based communications networks are one example of this type of communications network. (H.323 is an international telecommunications union (ITU) recommendation that describes terminals and entities that provide multimedia communication services over packet based networks which may not provide a guaranteed quality of service.)

One problem relates to how such gateways can be enabled to direct communications between terminals in such a way that takes into account cost information and/or the fact that telephone numbers (or other identifiers) are repeated in different parts of the communications network.

For example, consider a packet-based communications network which extends over different geographical areas and which has connections to a public switched telephone network from those different geographical areas. The cost to set up a communication session between a particular entity in the packet-based communications network and a particular entity in the public switched telephone network-will vary depending on which access point between the two communications networks is used. It is therefore required to enable gateways to direct communications in such a way that takes into account these differences in cost.

In another example, consider a packet-based communications network which supports two or more regions of that network used by different enterprises. Those enterprises each have a dialling plan which is used in that enterprise's region of the network to allocate telephone numbers or the like to terminals. These dialling plans may “overlap” in that some telephone numbers may be repeated between two or more of the regions. When a gateway directs a communication from a particular terminal to another terminal how is that gateway to know how best to forward the communication?

A particular example of a communications system in which these problems arise is an H.323 network using the Nortel Networks Succession (trade mark) system with the Nortel Networks Communications Server for Enterprise (CSE) 1000 as commercially available from Nortel Networks. Previously, time division multiplex (TDM) communications networks using network nodes such as Nortel Network's Meridian I (trade mark) switches have been used and in the evolution of such networks to the CSE 1000 network the problems that the present invention addresses have arisen.

FIG. 3 is a schematic diagram of a prior art Meridian 1 TDM communications network. The network 30 comprises a plurality of Meridian 1 nodes 32 with trunk connections 34 between those nodes 32. The connections 34 between the nodes 32 are all point-to-point connections. For direct connections between multiple nodes 32, dedicated point-to-point connections are required for each individual connection. If a point-to-point route is not available then it is necessary to tandem across intermediate nodes. For example, in FIG. 3 there are dedicated trunk routes between nodes A and C and nodes B and C. However, there is no direct point-to-point connection between nodes A and B. Node A has to tandem through node C in order to reach node B.

In this prior art network, it is necessary to configure a numbering plan database on each of the nodes 32. Thus, if a user at node A dials the number of a user at node B, the numbering plan database on node A indicates that the call needs to go out over the route to node C. Also, the numbering plan on node C indicates that the call needs to be routed to node B. However, the need for a numbering plan database at each node 32 creates a large administrative overhead.

An internet enabled version of the prior art Meridian 1 communications network has previously been developed as now described with reference to FIG. 4. Each of the Meridian nodes 32 is now connected to an Internet Protocol (IP) communications network 36 such as a wide area network or a local area network (WAN/LAN). Each node 32 comprises a gateway which allows connection between TDM nodes or terminals connected to the node 32 and the IP network 36. For example, this gateway may comprise an ITG Trunk 2.0 card. The Meridian 1 nodes 32 treat the ITG 2.0 cards as a trunk route. These trunk routes are point-to-multipoint. This means that regardless of where the terminating node is, all calls can be sent out over the same ITG 2.0 trunk route. Calls are routed to the correct destination over the packet based IP network 36 by the ITG 2.0 gateways.

Each ITG 2.0 node has its own numbering plan database and is configured with a static IP address for all the other ITG nodes on the network together with a numbering plan to route calls to the correct destination node. This is a large administrative overhead. When the Meridian 1 wishes to make an IP trunk call, the ITG card consults its numbering plan, determines where the destination is, retrieves the statically configured IP address and routes the call directly to the destination node.

The invention seeks to provide an improved method and apparatus for contacting a destination terminal from an originating terminal via a packet-based communications network which overcomes or at least mitigates one or more of the problems noted above.

Further benefits and advantages of the invention will become apparent from a consideration of the following detailed description given with reference to the accompanying drawings, which specify and show preferred embodiments of the invention.

### SUMMARY OF THE INVENTION

The present invention concerns packet-based communications networks in which gateways are used to direct communications between terminals. For example, H.323 based communications networks are one example of this type of communications network. One problem relates to how such gateways can be enabled to direct communications between terminals in such a way that takes into account cost information and/or the fact that telephone numbers (or other identifiers) are repeated in different parts of the communications network. This is addressed by providing a gatekeeper with cost information associated with each gateway. An originating gateway sends a request to the gatekeeper comprising a unique identifier of that originating gateway and an identifier for a destination terminal. The gatekeeper uses this information to provide a reply comprising a list of all possible gateways that can be used to contact the destination terminal or a single preferred gateway. The list is preferably ordered on the basis of cost information and/or depending on which region in the network that the originating gateway is located.

According to an aspect of the present invention there is provided a method of contacting a destination terminal from an originating terminal via a packet-based communications network. The communications network comprises a plurality of terminals connected to a plurality of gateways and also comprises a gatekeeper. The gatekeeper has information about each gateway comprising an identifier for each terminal connected to that gateway. The method comprises the steps of:—

sending a request from an originating gateway connected to the originating terminal to the gatekeeper, said request comprising the identifier of the destination terminal;

receiving a reply at the originating gateway from the gatekeeper said reply comprising information about at least one and possibly more of the gateways which can be contacted to reach the destination terminal.

This provides the advantage that the reply is able to comprise information about more than one gateway which can be contacted to reach the destination terminal. For example, the cost of taking the route via one of the possible gateways may be greater than the cost of taking the route via one of the other gateways. The originating gateway is then able to use the information in the reply to its advantage, for example, by trying the first gateway listed in the reply and if that fails, then using the next gateway listed in the reply.

In one embodiment the communications network comprises a first zone and a second zone each comprising a plurality of terminals connected to a plurality of gateways and wherein a plurality of the terminal identifiers of the first zone are also used for terminals of the second zone. For example, these zones or domains may be associated with particular enterprises which each use their own dialling plan. Because each enterprise is free to allocate terminal identifiers (e.g. telephone numbers) independently, terminal identifiers are typically repeated between zones. In this case the reply advantageously comprises information about each gateway that can be used to reach a particular terminal identifier that is specified.

In another example, the reply comprises information about only one gateway which is in the same zone as the originating terminal. For example, when telephone numbers are repeated between zones, then it may be assumed that a caller always requires to contact a destination with the same zone as the caller.

Preferably a unique label is assigned to each gateway. For example, this may be a H.323 standard alias. The gatekeeper has information about the unique label of each gateway and the request further comprises the unique label of the originating gateway. The gatekeeper is then able to base its reply on both the unique label of the originating gateway as well as the destination terminal identifier. This means that if the destination terminal identifier occurs in both zones, the reply received can be arranged to specify that a gateway in the originating zone should be contacted. This is achieved despite the fact that each gateway is unaware of which terminals are connected to other gateways in the communications network.

In another example, the gatekeeper comprises information about which terminals are accessible from each gateway together with cost information associated with accessing those terminals from each gateway. The reply then comprises information about each gateway that can be used to access the destination terminal together with associated cost information. For example the reply comprises a list of said gateways in order of the associated costs.

According to another aspect of the present invention there is provided a gatekeeper arranged for use in a packet-based communications network comprising a plurality of terminals connected to a plurality of gateways and wherein identifiers are associated with each terminal, said gatekeeper comprising:—

a memory arranged to store information about each gateway in the communications network said information comprising the identifier of each terminal connected to each gateway;

an input arranged to receive a request from a gateway in the communications network, said request comprising an identifier of a destination terminal;

an output arranged to send a reply to the requesting gateway, said reply comprising information about at least one and possibly more gateways which can be contacted to reach the destination terminal.

According to another aspect of the present invention there is provided a gateway arranged for use in a packet-based communications network comprising a plurality of terminals connected either to the gateway or to second gateways and wherein identifiers are associated with each terminal, said communications network further comprising a gatekeeper having information about each gateway comprising an identifier for each terminal connected to that gateway, said gateway comprising:—

a processor arranged to issue a request to the gatekeeper, said request comprising an identifier of a destination terminal;

an input arranged to receive a reply from the gatekeeper, said reply comprising information about at least one and possibly more of the second gateways which can be contacted to reach the destination terminal.

According to another aspect of the present invention there is provided a computer program for controlling a gatekeeper which is arranged for use in a packet-based communications network comprising a plurality of terminals connected to a plurality of gateways and wherein identifiers are associated with each terminal, said computer program being arranged to control said gatekeeper such that:—

information is stored about each gateway in the communications network said information comprising the identifier of each terminal connected to each gateway;

requests are received from gateways in the communications network, said requests comprising an identifier of a destination terminal; and

a reply is sent to the requesting gateway, said reply comprising information about at least one and possibly more gateways which can be contacted to reach the destination terminal.

According to another aspect of the present invention there is provided a computer program for controlling a gateway in order to contact a destination terminal from an originating terminal via a packet-based communications network which comprises a plurality of terminals connected either to the gateway or to second gateways and further comprising a gatekeeper, said gatekeeper having information about each gateway comprising an identifier for each terminal connected to that gateway, said computer program being arranged to control the gateway such that:—

a request is sent from the gateway to the gatekeeper, said request comprising the identifier of the destination terminal;

a reply is received at the gateway from the gatekeeper said reply comprising information about one and possibly more of the second gateways which can be contacted to reach the destination terminal.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 is a schematic diagram of a packet-based communications network comprising a gatekeeper and a plurality of gateways according to the present invention;

FIG. 2 is a schematic diagram of a packet-based communications network connected to a public switched telephone network via gateways which are arranged according to the present invention;

FIG. 3 is a schematic diagram of a Meridian 1 time division multiplex (TDM) communications network according to the prior art;

FIG. 4 is a schematic diagram of an internet enabled Meridian 1 TDM communications network according to the prior art;

FIG. 5 is a schematic diagram of a CSE 1000 Network according to the prior art.

FIG. 6 is a call flow diagram showing an example call flow between a CSE 1000 or other gateway, a gatekeeper and a packet-based network node (BCM);

FIG. 7 is another call flow diagram showing an example call flow between the same entities as for FIG. 6;

FIG. 8 is a schematic diagram of a packet-based communications network comprising components for a Nortel Networks Succession CSE 1000 (trade mark) internet protocol based communications system.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

The term “gateway” is used herein to refer to a communications network node which is connected to one or more terminals and which is also connected to a communications network such that the terminals are able to access the communications network via the gateway. An H.323 gateway is just one example of a type of gateway; any other suitable type of network node may be used.

The term “gatekeeper” is used herein to refer to a communications network node which is able to communicate with any gateways in the communications network and which maintains information about those gateways.

An example of one type of gatekeeper is an H.323 Gatekeeper which provides address translation and controls access to the network for H.323 terminals, Gateways and media control units (MCUs). A Gatekeeper may provide services to terminals, gateways and MCUs such as bandwidth management, although this is not essential.

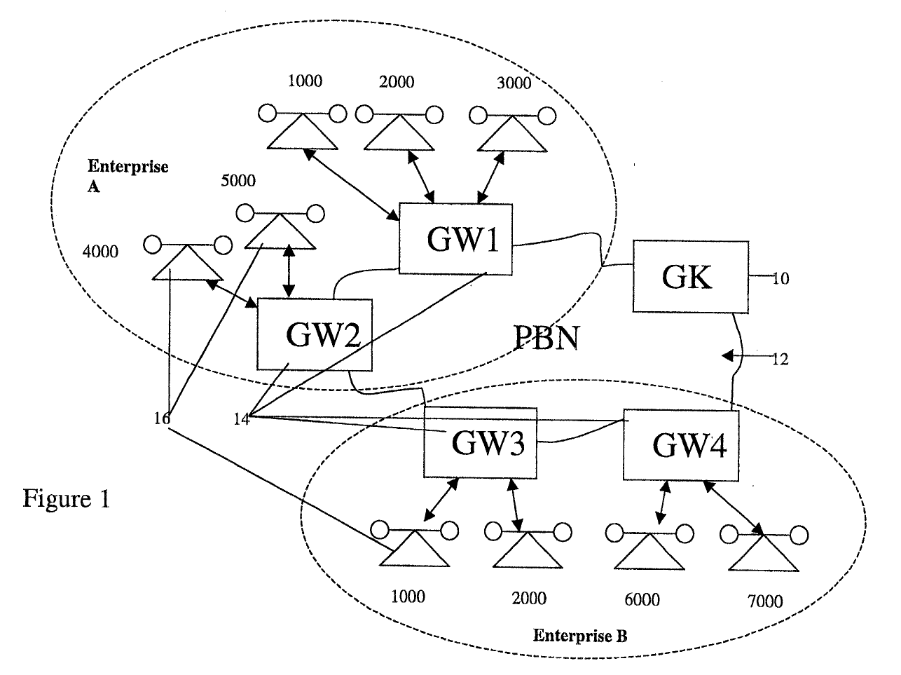

As mentioned above, packet-based networks may be arranged such that different regions of the network are used by different enterprises. This leads to problems where telephone numbers or other identifiers are repeated between those regions. For example, FIG. 1 shows a packet-based communications network (PBN) 12 comprising four gateways 14 (GW1, GW2, GW3, GW4) and a gatekeeper 10 (GK). Additional gateways may be used, although only four are shown here for clarity.

In the example being discussed different regions of the network are used by different enterprises. However, this does not imply that the methods and apparatus described herein are only applicable to enterprise networks; rather they are applicable to any suitable type of communications network including enterprise networks and carrier networks.

A plurality of terminals 16 are connected to each gateway 14 such that the terminals connected to a particular gateway 14 access the packet-based communications network 12 via that gateway 14. Each terminal has an associated identifier such as a telephone number and this is illustrated schematically in FIG. 1 by the numbers 1000 to 7000 next to the terminals 16. More information about the different types of identifier that can be used is given below in the section headed “terminal identifiers and unique labels for gateways”.

In the example shown in FIG. 1, GW1 and GW2 together with their terminals are allocated for use by enterprise A whilst GW3 and GW4 together with their terminals are allocated for use by enterprise B. Enterprise A has used a particular dialling plan to allocate telephone numbers to its terminals so that telephone numbers 1000, 2000, 3000, 4000 and 5000 are used as shown. Enterprise B has also allocated telephone numbers to its terminals so that telephone numbers 1000, 2000, 6000 and 7000 are used. Thus telephone numbers 1000, and 2000 are repeated between the two regions of the network The region of the PBN 12 associated with a particular enterprise is also referred to as a “customer domain”. A “domain” within the PBN is a region of that network which is associated with a particular enterprise or which has a particular function or use that is different from other regions of the network.

Each gateway 14 is aware of the terminals that are connected to it and has information about the telephone numbers of those terminals. However, none of the gateways are aware of any of the other gateways or which terminals are connected to those other gateways. This means that gateways do not know how to reach terminals that are not local to them. For example, if GW1 wishes to initiate communication between its terminal with telephone number 1000 and a terminal with telephone number 4000, it does not know which gateway on the network to use for contacting the terminal with telephone number 4000.

As is known in the art, a gatekeeper is used to solve this problem. The gatekeeper is arranged to know which terminals are connected to each gateway. For example, the gatekeeper may be configured with this information or the gateways may be arranged to inform the gatekeeper of their presence and which terminals they support, during a registration process.

When a gateway wishes to initiate communication over the PBN 12 it sends an Admission Request (ARQ) to the gatekeeper 10. If an H.323 network is used, this admission request takes the form of a standard H.323 ARQ message. The request message comprises information about a destination terminal such as the telephone number or other identifier of a terminal which it is required to contact. The term “originating gateway” is used herein to refer to the gateway from which the request message is sent and similarly, “originating terminal” refers to the terminal from which the requested communication began. The “destination terminal” and “destination gateway” are those entities which the originating terminal requires to contact.

Once the gatekeeper 10 receives the request message it uses the information it has about each gateway to determine which gateway is to be contacted in order to reach the destination terminal. In the present example, if the destination terminal has a telephone number of 4000, then the gatekeeper sends a reply to the requesting gateway indicating that GW2 is to be contacted. This reply message is preferably an H.323 Admission Confirm message in the case that the PBN 12 is an H.323 network. On receipt of the reply message, GW1 knows that the terminal with identifier 4000 can be reached via GW2 and so it contacts GW2 in order to initiate communication.

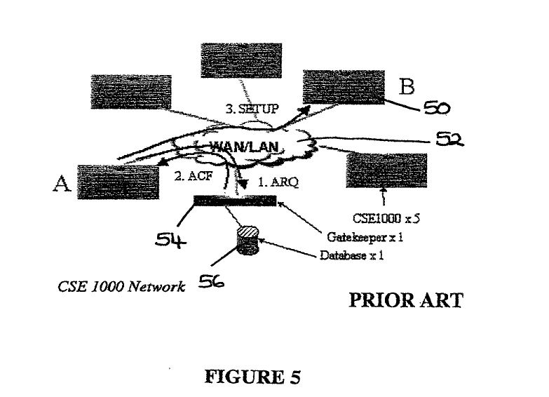

This type of prior art method is found in Nortel Networks CSE1000 networks such as that illustrated in FIG. 5. This example shows one zone of a CSE 1000 network which has a single active gatekeeper 54 (other zones could also be present, each with their own single active gatekeeper). A plurality of gateways 50 are connected to a packet-based communications network 52 and in this example, each gateway is a CSE1000 node. The gatekeeper has access to a numbering plan database 56 and the gatekeeper itself may be resident in any of the CSE1000 nodes 50. The numbering plan database is configured with numbering plan information for each CSE1000 node in the network zone. When a CSE1000 node wishes to place an IP call to another CSE1000 node, the originator sends an admission request to the gatekeeper specifying the destination phone number. The gatekeeper consults its internal numbering plan database and replies as described above.

As mentioned above, one problem with this prior art method arises when terminal identifiers are repeated.

In a first embodiment of the present invention, this problem is addressed by arranging the gatekeeper to provide details of all possible gateways that can be contacted to reach the required terminal identifier. Thus the reply message comprises details of one or more gateways. These details can be presented to a user at the originating terminal who is then able to select which gateway should be used.

In a second embodiment, the gatekeeper itself is arranged to select only one of the possible gateways and return information only about that selected gateway in the reply message. The gatekeeper selects a gateway in one of a plurality of ways. For example, in a preferred embodiment, the request message contains the unique label of the requesting gateway. The gatekeeper has information about which gateways are associated with particular enterprises and includes in the reply message details of the gateway that is associated with the same enterprise as the requesting gateway. That is, it is assumed that the originator of the communication request wishes to contact a terminal within the same enterprise (or other communications network region) as themselves. For example, when the gatekeeper receives an ARQ it determines the gateway which originated the request by obtaining the gateway unique label from the request message. The gatekeeper then determines which customer domain the originating gateway belongs to, by using the information available to the gatekeeper. The gatekeeper then assumes that the destination terminal is in the same domain as the originating gateway and searches in that domain only for the correct terminal identifier. It is also possible to assume the opposite and always return details of a gateway that is associated with a different network domain.

The gatekeeper can also select one of the possible gateways in any other suitable manner. For example, the gatekeeper may store information about past communications history between gateways and use this information to make the selection. The gateway that has most often been involved in communication with the originating gateway could be selected.

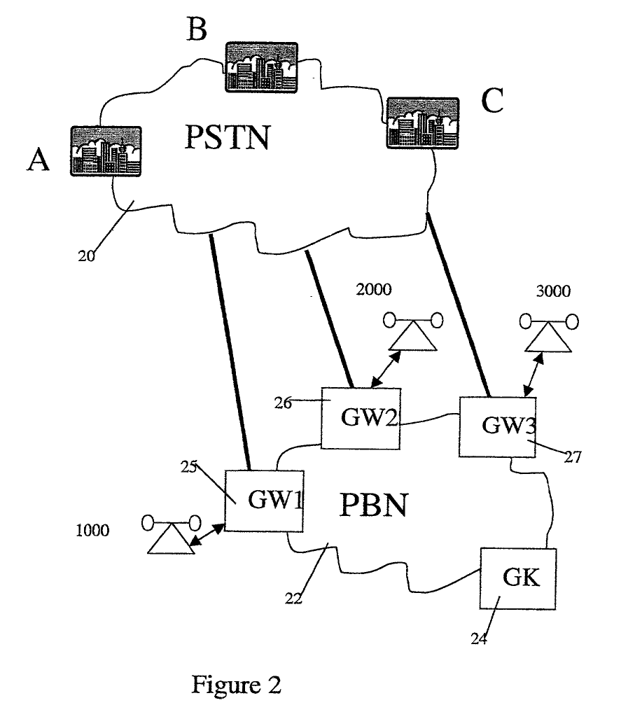

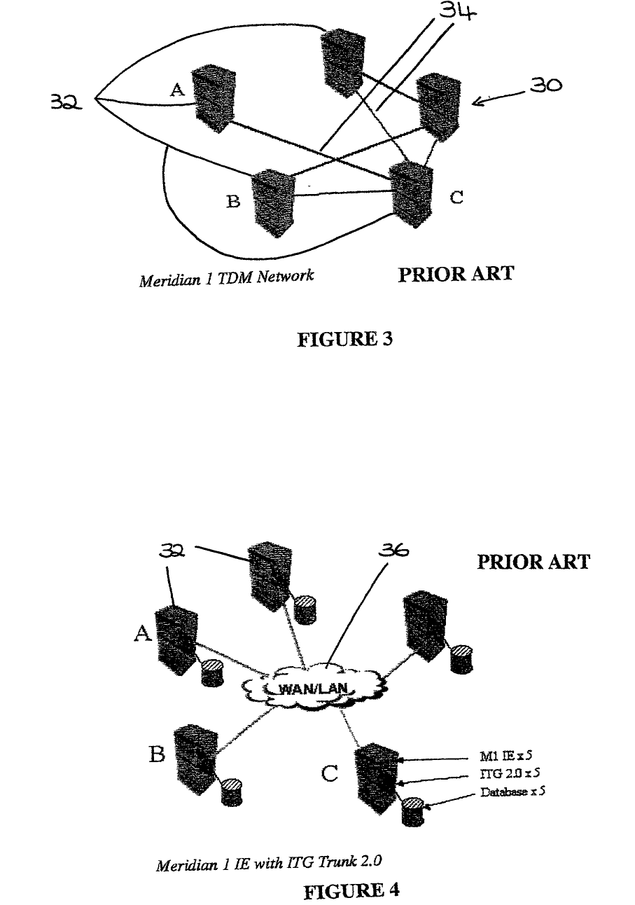

In another embodiment the gatekeeper has access to cost information. This is now discussed with reference to FIG. 2 which shows a packet-based communications network (PBN) 22 comprising three gateways GW1 25, GW2 26, GW3, 27 and a gatekeeper GK 24. Each gateway is connected to a public switched telephone network 20 which has three regions or domains A, B and C. Each gateway is also connected to a terminal which has a terminal identifier (e.g. telephone number, email address, universal resource locator (URL) etc.) as indicated in FIG. 2.

In this embodiment, any of the domains A, B or C can be reached from any of the plurality of gateways 25, 26, 27 so that alternative routes exist. In this case, consider a situation where terminal 1000 wishes to contact a terminal at region C. The originating gateway GW1 sends a request message to the gatekeeper 24 containing the identifier of a destination terminal in region C. Any of the gateways can be used to contact the destination terminal and so the gatekeeper is able to reply giving details of all of the gateways. Alternatively, the gatekeeper could select one of those possible gateways and give details of only that gateway in the reply.

In order to make this selection the gatekeeper preferably uses cost information in the case where the costs associated with accessing the regions A, B and C differ according to which of the gateways is used. For example, consider the situation where it is cheapest to access location A via GW1, location B via GW2 and location C via GW3. However, to access the locations from other gateways is more expensive. For example, it is more expensive to access location A via GW2 and more expensive again via GW3. The gatekeeper is pre-configured with information about these different relative costs and is arranged to send replies comprising a list of all the possible gateways that can be used to reach a particular destination, in order of relative cost. The originating gateway is then able to attempt to route the communication session over the cheapest route first. If that fails, then the next cheapest route may be tried and so on. Any other suitable strategies may be used based on the cost information. For example, the gatekeeper may only include details of the gateway providing the cheapest route in the reply.

In another embodiment, each gateway is provided with a unique label as mentioned above. When a request is sent to the gatekeeper, the unique label of the originating gateway is included in the request and the gatekeeper replies on the basis of that unique label and the cost information as well as the identifier of the destination terminal. In this way, depending on which originating gateway is used, different alternate routes may be returned in a different order of preference.

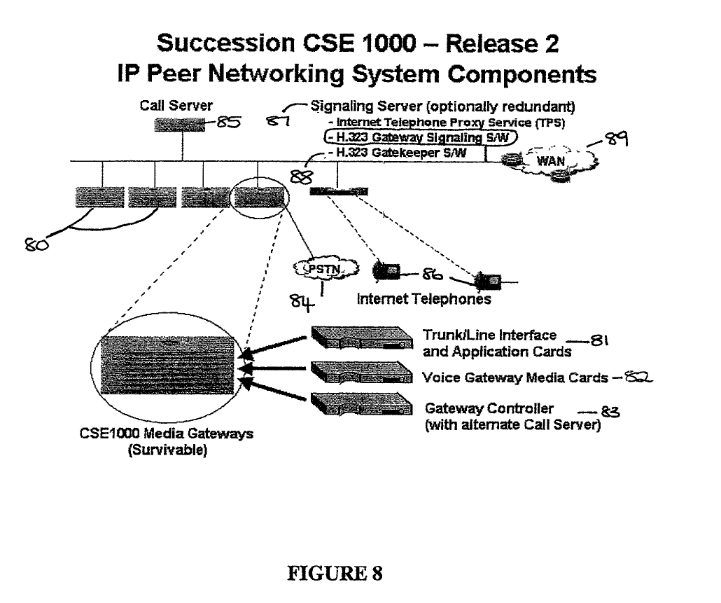

In the example discussed above any suitable type of gateways, gatekeeper and terminals may be used. For example, as mentioned above, a Nortel Networks Succession CSE 1000 (trade mark) network is preferably used. FIG. 8 illustrates the key components of such a network. These comprise a packet-based communications network with a plurality of CSE1000 media gateways 80. Each CSE1000 media gateway 80 itself comprises a trunk/line interface and application cards 81, voice gateway media cards 82, and a gateway controller 83. These CSE1000 media gateways 80 are also connected to a public switched telephone network (PSTN) 84 as indicated and thus allow analogue terminals within the PSTN to communicate with the packet-based communications network.

A call server 85 is also connected to the packet-based communications network and is arranged to control the call processing features of terminals and trunk interfaces. Other terminals, such as internet telephones 86 may also be provided, which communicate with the packet-based communications network via a signalling gateway 87 as shown by dotted lines in FIG. 8. In FIG. 8 only one signalling gateway 87 is shown because FIG. 8 is intended to illustrate only those components used at a single enterprise site. More signalling gateways 87 are used as required (for example, within the wide area network 89 of FIG. 8) and these correspond to the gateways of FIGS. 1 and 2. Thus the internet telephones 86 correspond to the terminals of FIGS. 1 and 2 as do terminals within the PSTN 84 although these are indirectly connected to the signalling server 87 via the CSE1000 media gateways 80.

A gatekeeper 88 is provided in the form of software on one of the signalling gateways 87. It is not essential fot the gatekeeper to be integral with the signalling server in this way but one advantage of doing this is that hardware requirements are reduced. Only one gateway is used per network zone as described above. In the case that the originating terminal is in the PSTN 84, an admission request is forwarded from the relevant CSE1000 media gateway to the signalling server 87 and from there to the gatekeeper 88.

Terminal Identifiers and Unique Labels for Gateways

The ‘identifiers’ for referring to terminals and the ‘labels’ for referring to gateways may comprise any suitable type of H.323 alias name. An alias name in the current version of the H.323 standard can be: url-ID; h323-ID; email-ID; transportID (IP address (this is actually IP version 4), IP version 6 address, IPX address, netBios address); dialled digit string; mobileUIM (for 2G and 3G mobile wireless networks); or telephony number (which can be international (e.g. 353 91 733360), national (e.g. 091 733360), subscriber (e.g. 733360), private (e.g. ESN 570 3360) etc.). The alias assigned to the terminal or the gateway can be any of the H.323 standard aliases.

Both terminal and gateway could conceivably have ‘identifiers’ or ‘labels’ of the same type as long as they were grouped together and associated with either terminals or gateways so that the gatekeeper could still distinguish between them.

A particular example of a method for dealing with repeated telephone numbers or other terminal identifiers is now discussed, with reference to a Nortel Networks CSE1000 network although any other suitable type of network may be used.

Endpoints (e.g. gateways) requiring admission to the network and address translation services discover their gatekeeper using mechanisms known in the art. After gatekeeper discovery is complete, the endpoints register with the Gatekeeper using a Registration Request (RRQ) message. The endpoints provide an abstract h323-ID alias name and an associated H.225/Q.931 call signalling address in the RRQ.

A network numbering plan is administered on the Gatekeeper. Predefined endpoint h323-ID alias names are configured on the Gatekeeper along with an associated list of the telephony E.164/Private numbers/number ranges which the endpoints support. When a predefined endpoint registers, the Gatekeeper extracts the H.225/Q.931 call signalling address from the RRQ and associates this with the endpoint in its internal database.

For example, a CSE1000 gateway in Galway supports public E.164 numbers +353 91 XXXXXX and private ESN numbers 570 XXXX. The gateway is configured on Gatekeeper as:

| | |
|---|---|
| h323-ID: | CSE_GALWAY_1 |
| Public E.164 support: | +353 91 XXXXXX |
| Private ESN support: | 570 XXXX |

The CSE1000 has an IP address of 47.85.2.201. This is both the RAS signalling transport address and the call signalling transport address. When the CSE1000 registers the following parameters are in the RRQ fields terminalAlias.h323-ID and callSignalAddress:

| | |
|---|---|
| h323-ID | CSE_GALWAY_1 |

Call signalling IP address: 47.85.2.201

The Gatekeeper associates the call signalling transport address 47.85.2.201 with the h323-ID and numbering plan for this node that it preconfigured in its database.

When a registered endpoint wants to place a call across the network it sends an ARQ containing the fully qualified destination telephony number to the Gatekeeper. The Gatekeeper searches through the list of telephony numbers supported by the predefined endpoints and finds the endpoint which will terminate this call. Assuming the terminating endpoint has already registered with its H225/Q.931 call signalling address, the Gatekeeper returns an Admission Confirmation (ACF) to the originator including the call signalling address of the selected terminator.

For example, a user in Belleville wants to dial Galway ESN 570 3360. Based on the users local dialing plan, the user dials 65703360. The local call server (or VTrunk Signalling Proxy, ITG2+, etc.) modifies the dialled number and presents the H.323 signalling proxy with the fully qualified private ESN number 570 3360. The H.323 proxy requests address translation by sending an ARQ to the Gatekeeper with ESN 570 3360 in the destinationinfo.partyNumber.privateNumber alias field. The Gatekeeper consults its numbering plan database and finds the endpoint which terminates this number, namely CSE_GALWAY_{—}1. As this node has previously registered its call signalling transport address, the Gatekeeper retrieves this address and returns it to the calling endpoint in the destCallSignalAddress field of an ACF.

Using this mechanism, the originating endpoint only needs to know the IP address of the Gatekeeper, it does not need to know the IP address of the terminating endpoint as this is returned by the Gatekeeper in the ACF.

Upon receipt of the ACF, the originating endpoint extracts the destCallSignalAddress and sends the H.225/Q.931 SETUP message to the terminator. When the terminator receives the SETUP it responds immediately by sending a H.225/Q.931 CALL PROCEEDING message to the originator. The call signalling IP address of the originator is contained in the message.setup.userUser.h323-UserInformation.h323-uu-pdu.h323-message-body.setup.sourceCallSignalAddress field of the SETUP message. The CALL PROCEEDING is sent in order to prevent a timeout occurring on the originator.

The Gatekeeper pre-grants ARQ for the call terminator, however the terminator may still send an ARQ to the Gatekeeper. If the terminator sends an ARQ to the Gatekeeper, the answerCall field of this ARQ is set to indicate that it is a request for admission from the call terminator. As per the H.323 standard, this ARQ contains the destination phone number ESN 570 3360 in the destinationInfo.partyNumber.privateNumber alias field and not the originators phone number.

The Gatekeeper performs an address translation and returns the call signalling transport address of the CSE_GALWAY_{—}1 node in the destCallSignalAddress field of the ACF.

On receipt of the ACF, the terminating endpoint proceeds with H.225/Q.931 call setup as normal.

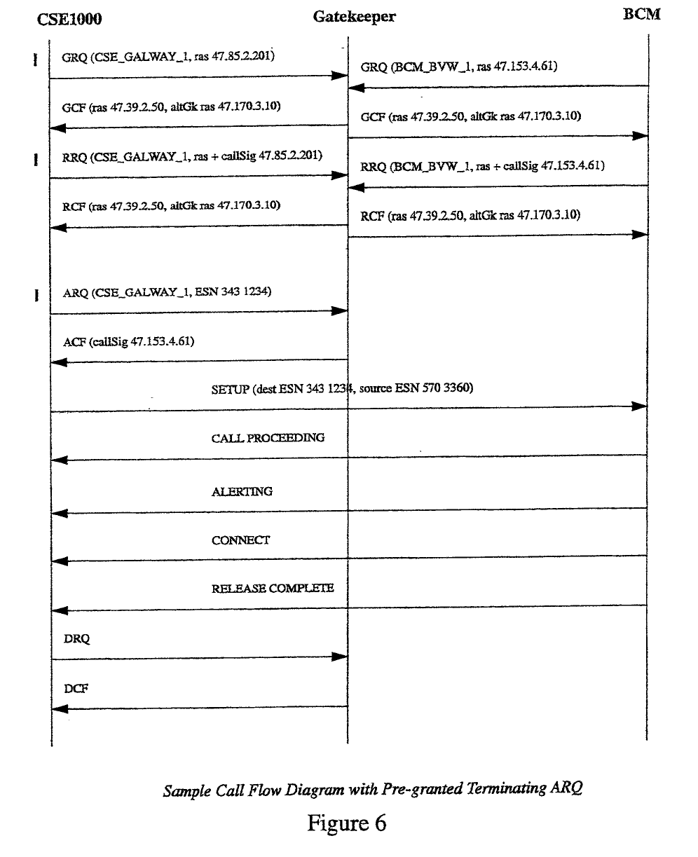

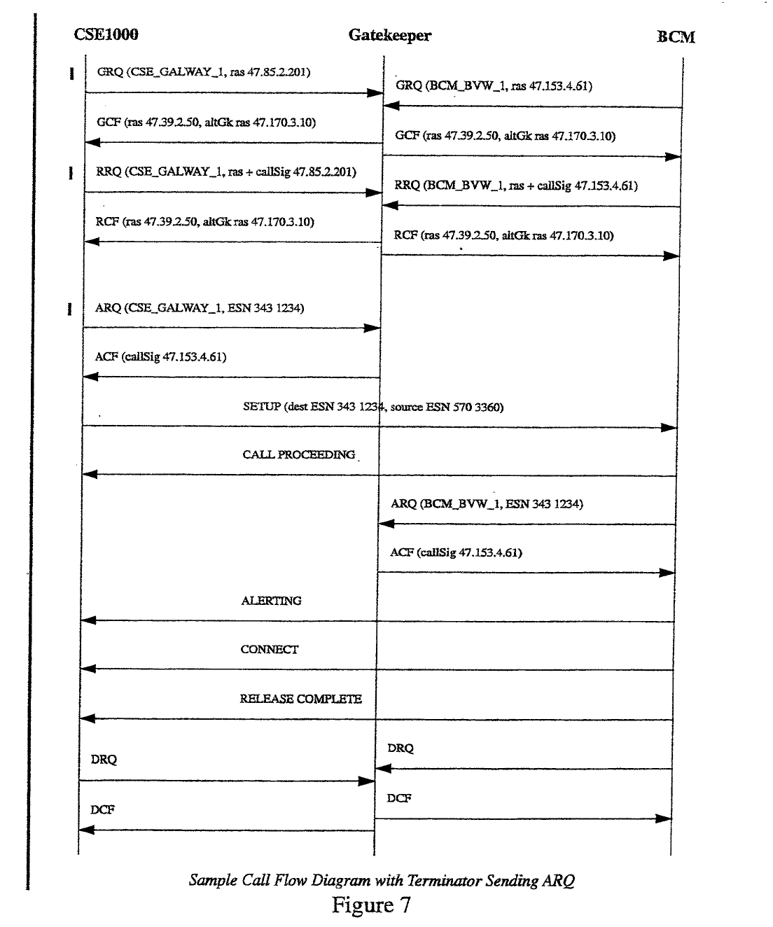

Two example call flow diagrams, including gatekeeper discovery and registration, are given in FIG. 6 and FIG. 7. FIG. 6 shows the call flow for the case where the terminator does not send ARQ for admission. FIG. 7 shows the case where the terminator ignores the fact that the Gatekeeper has pre-granted ARO for the call terminator and sends ARQ for admission anyway. In both examples a user in Galway dials ESN 343 1234 to reach a user in Belleville. The following network configuration is assumed:

| CSE1000 node in Galway: | |
|---|---|
| h323-ID | CSE_GALWAY_1 |
| Private ESN Support | 570 XXXX |
| RAS IP Address | 47.85.2.201 |
| Call Signalling IP Address | 47.85.2.201 |

| BCM node in BVW: | |
|---|---|
| h323-ID | BCM_BVW_1 |
| Private ESN Support | 343 XXXX |
| RAS IP Address | 47.153.4.61 |
| Call Signalling lP Address | 47.153.4.61 |

| Primary Gatekeeper: | |
|---|---|
| RAS IP Address | 47.39.2.50 |

| Alternative Gatekeeper: | |
|---|---|
| RAS IP Address | 47.170.3.10 |

A particular example of a method which uses cost information is now described with reference to a Nortel Networks CSE1000 network although any other suitable type of network could be used.

A very useful feature is to provide alternate/least cost routes. For example, when tandeming a call across the IP network in order to gain access to the PSTN, if the Gatekeeper only returns one terminating IP gateway in the ACF and if this gateway is currently unreachable, or all channels are busy, etc. then the call will fail.

Least cost routing is provided as follows. When configuring a predefined numbering plan translation entry for an endpoint on the Gatekeeper, the h323-ID of the endpoint which will terminate this numbering plan entry is configured as, say, BCM_BVW_{—}1. The administrator must also configure the ‘Cost Factor’ associated with this route. The cost factor is an integer value in the range 1 to 255. Multiple endpoints may be configured with numbering plan entries with the same leading digit range but different cost factors. If the administrator does not provide a cost factor then it will be defaulted to 1.

For example, a node in Belleville (BCM_BVW_{—}1) may be configured to support public international E.164 number 1613 with a cost factor of 1. A node in Toronto (CSE_TOR_{—}1) may also be configured with E.164 support for 1613 but with a cost factor of 2. When handling an ARQ the Gatekeeper returns the IP address of the endpoint (if registered) which terminates this number with the lowest cost factor in the destCallSignalAddress field of the ACF and the IP address of the alternate endpoints (if registered) which terminate this number but with a higher cost factor in the alternateEndpoints field of the ACF. If the primary (or least cost) endpoint is not registered then the IP address of the first alternate (or higher cost) endpoint which is registered is returned in destCallSignalAddress and any other alternate endpoints which are registered have their IP addresses returned in alternateEndpoints. In this simple example if the Gatekeeper received an ARQ for E.1 64 number 1613XXXXXXX it would return the IP address of BCM_BVW_{—}1 in the destCallSignalAddress field and the IP address of CSE_TOR_{—}1 in the alternateEndpoints field of the ACF.

Any range or device value given herein may be extended or altered without losing the effect sought, as will be apparent to the skilled person for an understanding of the teachings herein.

A range of applications are within the scope of the invention. These include situations in which it is required to contact a destination terminal from an originating terminal over a packet-based communications network. In particular, situations in which terminal identifiers are repeated and/or in which alternative routes with different associated costs are involved are dealt with.

1. A method of contacting a destination terminal from an originating terminal via a packet-based communications network which comprises a plurality of terminals connected to a plurality of gateways and further comprising a gatekeeper, said gatekeeper having information about each gateway comprising an identifier for each terminal connected to that gateway and said method comprising the steps of:—
(i) sending a request from an originating gateway connected to the originating terminal to the gatekeeper, said request comprising the identifier of the destination terminal;
(ii) receiving a reply at the originating gateway from the gatekeeper said reply comprising information about at least one and possibly more of the gateways which can be contacted to reach the destination terminal.

2. A method as claimed in claim 1 wherein said communications network comprises a first zone and a second zone each comprising a plurality of terminals connected to a plurality of gateways and wherein a plurality of the terminal identifiers of the first zone are also used for terminals of the second zone.

3. A method as claimed in claim 2 wherein said reply comprises information about only one gateway which is in the same zone as the originating terminal.

4. A method as claimed in claim 1 wherein a unique label is assigned to each gateway.

5. A method as claimed in claim 4 said gatekeeper has information about the unique label of each gateway.

6. A method as claimed in claim 4 wherein said request further comprises the unique label of the originating gateway.

7. A method as claimed in claim 5 wherein said reply comprises information provided by the gatekeeper on the basis of the unique label of the originating gateway as well as the destination terminal identifier.

8. A method as claimed in claim 2 wherein if the destination terminal identifier occurs in both zones, the reply received specifies that a gateway in the originating zone should be contacted.

9. A method as claimed in claim 2 wherein the first zone is associated with a first enterprise and a second zone is associated with a second enterprise.

10. A method as claimed in claim 1 wherein the identifiers are of a type selected from telephone numbers, universal resource identifiers (URLs), email addresses or any other suitable type of H.323 standard alias.

11. A method as claimed in claim 4 wherein the unique labels comprise any suitable type of H.323 standard alias.

12. A method as claimed in claim 1 wherein the request is an H.323 admission request.

13. A method as claimed in claim 1 wherein the reply is an H.323 admission confirm message.

14. A method as claimed in claim 1 wherein each gateway is unaware of which terminals are connected to other gateways in the communications network.

15. A method as claimed in claim 1 wherein said gatekeeper further comprises information about which terminals are accessible from each gateway together with cost information associated with accessing those terminals from each gateway.

16. A method as claimed in claim 15 wherein said reply comprises information about each gateway that can be used to access the destination terminal together with associated cost information.

17. A method as claimed in claim 16 wherein said reply comprises a list of said gateways in order of the associated costs.

18. A gatekeeper arranged for use in a packet-based communications network comprising a plurality of terminals connected to a plurality of gateways and wherein identifiers are associated with each terminal, said gatekeeper comprising:—
(i) a memory arranged to store information about each gateway in the communications network said information comprising the identifier of each terminal connected to each gateway;
(ii) an input arranged to receive a request from a gateway in the communications network, said request comprising an identifier of a destination terminal;
(iii) an output arranged to send a reply to the requesting gateway, said reply comprising information about at least one and possibly more gateways which can be contacted to reach the destination terminal.

19. A gatekeeper as claimed in claim 18 wherein said memory is further arranged to store cost information relating to the cost of accessing each available terminal from each gateway.

20. A gatekeeper as claimed in claim 18 wherein a unique label is assigned to each gateway and wherein said memory is arranged to store the unique label of each gateway.

21. A gatekeeper as claimed in claim 20 wherein said request further comprises the unique label of the originating gateway connected to the originating terminal.

22. A gateway arranged for use in a packet-based communications network comprising a plurality of terminals connected either to the gateway or to second gateways and wherein identifiers are associated with each terminal, said communications network further comprising a gatekeeper having information about each gateway comprising an identifier for each terminal connected to that gateway, said gateway comprising:—
(i) a processor arranged to issue a request to the gatekeeper, said request comprising an identifier of a destination terminal;
(ii) an input arranged to receive a reply from the gatekeeper, said reply comprising information about at least one and possibly more of the second gateways which can be contacted to reach the destination terminal.

23. A gateway as claimed in claim 22 wherein said request comprises a unique label which is associated with the gateway.

24. A gateway as claimed in claim 22 wherein said reply comprises cost information.

25. A communications network comprising a gateway as claimed in claim 22.

26. A communications network comprising a gatekeeper as claimed in claim 18.

27. A computer program for controlling a gatekeeper which is arranged for use in a packet-based communications network comprising a plurality of terminals connected to a plurality of gateways and wherein identifiers are associated with each terminal, said computer program being arranged to control said gatekeeper such that:—
(i) information is stored about each gateway in the communications network said information comprising the identifier of each terminal connected to each gateway;
(ii) requests are received from gateways in the communications network, said requests comprising an identifier of a destination terminal; and
(iii) a reply is sent to the requesting gateway, said reply comprising information about at least one and possibly more gateways which can be contacted to reach the destination terminal.

28. A computer program for controlling a gateway in order to contact a destination terminal from an originating terminal via a packet-based communications network which comprises a plurality of terminals connected either to the gateway or to second gateways and further comprising a gatekeeper, said gatekeeper having information about each gateway comprising an identifier for each terminal connected to that gateway, said computer program being arranged to control the gateway such that:—
(i) a request is sent from the gateway to the gatekeeper, said request comprising the identifier of the destination terminal;
(ii) a reply is received at the gateway from the gatekeeper said reply comprising information about one and possibly more of the second gateways which can be contacted to reach the destination terminal.
